(19) United States
(12) Patent Application Publication
(10) Pub. No.: US 2010/0119815 A1
(43) Pub. Date: May 13, 2010

(54) Preparation Method of Nanodiamond and Nanocarbon with the Same Atomic Ratio of Hydrogen and Halogen Among the Chemical Compound of Carbon, Hydrogen and Halogen by Dehydrohalogenation and Their Production

(76) Inventor: Jong-Hoon Kim, Daejeon (KR)

Correspondence Address: THE WEBB LAW FIRM, P.C., 700 KOPPERS BUILDING, 436 SEVENTH AVENUE, PITTSBURGH, PA, 15219, US

(21) Appl. No.: 12/530,700

(22) PCT Filed: Mar. 11, 2008
(86) PCT No.: PCT/KR2008/001377

§ 371 Date: Nov. 4, 2009

(30) Foreign Application Priority Data
Mar. 12, 2007 (KR) 10-2007-0024164
Jun. 4, 2007 (KR) 10-2007-0054265
Jul. 10, 2007 (KR) 10-2007-0069083
Oct. 8, 2007 (KR) 10-2007-0100785

(51) Int. Cl. B32B 5/16; B32B 1/00; C01B 31/06; C01B 31/02

(52) U.S. Cl. 428/323; 428/368; 423/446; 423/445 B; 977/734; 977/700; 977/842

(57) ABSTRACT

The present invention relates to nanocarbon with the compound of 1:1 atomic number ratio of hydrogen and halogen among chemical compounds of carbon, hydrogen, and halogen and a preparation method thereof. The present invention relates to a new preparation method of carbons in various forms such as nanodiamond, fullerene, nanographite, carbon onion, carbon nanotube, carbon nanofiber with the compound of 1:1 atomic number ratio of hydrogen and halogen among chemical compounds of carbon, hydrogen, and halogen by dehydrohalogenation.

### TECHNICAL FIELD

The present invention relates to a preparation method of carbons in various forms such as nanodiamond, fullerene, nanographite, carbon onion, carbon nanotube, carbon nanofiber with the compound of 1:1 atomic number ratio of hydrogen and halogen among chemical compounds of carbon, hydrogen, and halogen by dehydrohalogenation by mean of a reaction of them with a base and provides a new preparation method of carbon in various forms, such as nanodiamond, fullerene, nanographite, carbon onion, carbon nanotube, carbon nanofiber, or the like, at low costs.

### BACKGROUND ART

With the development of science, a use of nanocarbon substances, such as nanodiamond, fullerene, nanographite, carbon onion, carbon nanotube, carbon nanofiber, or the like, is gradually growing. As a conventional preparation method of carbon, there have been many synthetic methods of nanocarbon substances, such as nanodiamond, fullerene, nanographite, carbon onion, carbon nanotube, carbon nanofiber, or the like. However, most synthetic processes are poor economy due to high production costs and products prices are significantly high so that it is difficult to substantially apply the synthetic methods to a product.

The present inventor found during the search of a simple preparation method of carbon without subjecting to complicated processes that nanocarbons in various forms with the compound of 1:1 atomic number ratio of hydrogen and halogen among chemical compounds of carbon, hydrogen, and halogen can be prepared by dehydrohalogenation and carbons such as nanodiamond, fullerene, nanographite, carbon nanotube, carbon nanofiber, or the like can be mass-produced at low costs.

### DISCLOSURE

### [Technical Problem]

An object of the present invention is to provide a new preparation method that can economically mass-produce nanocarbon.

Also, another object of the present invention is to provide a new method capable of very easily carbon without adopting a process requiring high energy as in an arc discharge scheme, high temperature heating scheme, etc. for preparing the existing nanocarbon.

### [Technical Solution]

With the preparation method, various elements, that is, various metals of such as copper, silver, etc. in a metal state or an ion state can be impregnated into carbon particles, metal salt and metal oxide, etc. can be impregnated into carbon particles, and particular organic compound can be confined inside carbon particles. Also, the preparation method provides a way to change a form of carbon such as carbon nanotube, carbon nanofiber, diamond nanotube, etc. by using metals, such as iron, cobalt, nickel, etc., in a state where they are directly impregnated into a carrier or in a chelating state. Also, the preparation method provides a way to prepare a graphite or diamond sheet on a metal plate by using the various metal plates such as nickel, etc. In other words, several kinds of carbon sheets can be prepared by a method of forming the nanocarbon layer on the plate having several catalyst characteristics or easily removing these characteristics and then melting the plate, etc. Also, the preparation method of the present invention provides a way to form a carbon layer such as graphite or diamond, etc on a surface of several objects such as metal, plastic, fiber, carbon nanotube, optical fiber, etc. In other words, as in examples of a tenth embodiment and an eleventh embodiment, a synthetic method of nanocarbon is performed on a target intending to form the carbon layer dipped into a reaction solution so that the carbon layer is formed on the surface of the target.

In other words, the present inventor completes the present invention by preparing carbon of nano particles with the compound of 1:1 atomic number ratio of hydrogen and halogen among chemical compounds of carbon, hydrogen, and halogen by dehydrohalogenation that removes halogen acid using a base and controlling the size of carbon using water, organic solvent, or a mixture thereof.

In particular, the present invention prepares carbons in various forms by inputting water or organic solvent, impregnated metal, chelated metal, metal salt, metal oxide, and particular organic matters, etc. separately or in combination thereof according to a desired purpose and then inputting a base and reacting them, so as to control the form of carbon with the compound of 1:1 atomic number ratio of hydrogen and halogen among chemical compounds of carbon, hydrogen, and halogen. Also, generally used dispersant may be used so as to the form of carbon. In the present invention, it is apparent to those skilled in the art that the added substances do not substantially participate in the reaction in the dehydrohalogenation and do not hinder the dehydrohalogenation even though it participates in the dehydrohalogenation.

The preparation method according to the present invention provides the preparation method of carbons with the compound of 1:1 atomic number ratio of hydrogen and halogen among chemical compounds of carbon, hydrogen, and halogen by dehydrohalogenation, comprising the steps of: 1) preparing a reaction solution by directly using the compound of 1:1 atomic number ratio of hydrogen and halogen among chemical compounds of carbon, hydrogen, and halogen or by inputting and dissolving them into organic solvent; 2) inputting base compound into the group; 3) raising the temperature of the group into which the base compound is input and reacting it;

and 4) purifying reaction products.

Also, the steps 1) to 4) are sequentially repeated on a portion of products, purified products, or carbon substances with different sizes capable of performing a role of seed or core at the step 4), making it possible to control the reaction and increase the size of carbon particle.

Also, the preparation step of carbon uses at least one selected from a group consisting of polymer substance, surfactant, reactive phenolic substance, and amine to give hydrophilic or lipophilic property, making it possible to improve dispersibility and provides radical during the reaction, making it possible to change the carbon. Also, gas phase substances of nitrogen, helium, neon, or a mixture thereof are inflowed into the reactor so that they may be included in the inside of the carbon.

The organic solvent used in the present reaction is used to be matched with the desired or intended carbon substance with the compound of 1:1 atomic number ratio of hydrogen and halogen among chemical compounds of carbon, hydrogen, and halogen. The solvent with good compatibility may be used without restriction for the compound of 1:1 atomic number ratio of hydrogen and halogen among chemical compounds of carbon, hydrogen, and halogen and the products, however, the combination capable of well generating the desired products using each discrepancy in solubility according to a sort of the desired products may be used. Also, it is possible to apply the solvent with poor compatibility to both the reactants and products.

Also, water and alcohol having less affinity for carbon, aromatic-based solvent having good affinity for carbon, ketones, amides, and amine solution, etc. are used separately or in plurality according to the desired products. Also, when there are substances intending to put into carbon nano particles, desired substances such as chloroform, bromoform, etc. may be used as a solvent.

Although it is important to select the solvent depending on substance intended to prepare, it seems that how core is formed during the process of synthesizing nanodiamond acts as an important factor in determining which nanocarbon the prepared substance is. In other words, if fullerene C₂₄ is prepared as the core, it seems that it is grown as the nonocarbon in a round form such as carbon onion, etc. and fullerene C₂₀ is prepared as a core, it seems that it is nonodiamond. Since it is considered that the entire synthetic process is performed simultaneously with the chemical reaction as a model of a crystal growth, it is important to well select the kinds of solvents or amines capable of well dissolving each core and to well use the seed according to the targeted substances. Since the fullerenes C₂₄, C₂₀ acting as the cores has hydrophilic property, it is important to well select the hydrophilic solvent.

In the step of preparing the reaction solution of the present invention, the dissolution temperature is not limited, but is generally in the range of 5 to 100° C. Next, as the base compound of the present reaction, the compound of substances changed from relatively small basicity to relatively large basicity is used according to the desired products so that the reaction can be changed. The form of carbon is controlled by well selecting the kind of base together with the temperature condition according the desired products such as nanodiamond, fullerene, nanographite, carbon onion, carbon nanotube, carbon nanofiber, etc. As the usable components, metal hydroxide, metal alkoxide, ammonia, or amine, etc. may be used. As the metal, alkali metal, alkaline earth metal, etc. may be used. As the amine, primary amine, secondary amine, tertiary amine, and quaternary amine, substances whose one molecule includes at least one amine, and a hetero amine including at least one amine and other elements may be used. As examples of amines, there are aniline, trimethylamine, N-oxide, pyridine, hydroxylamine, 2,6-dimethylpyridine, imidazole, hydrazine, aziridine, 2,2,2-trifluoroethylamine, morpholine, N-alkylmorpholine, DABCO, sodiumamide, lithiumamide, 4-dimethylamionpyridine, ethylamine, triethylamine, diethylamine, piperidine, pyrrolidine, DBU, guanidine, pentamethylguanidine, phenylamide, indole, pyrrole, urea, diphenylamine, p-nitroamine, etc.

Also, the form of targeted carbon may be controlled by controlling the kinds of reactants intending to perform dehydrochlorination.

Also, the reaction temperature in the present invention is preferably in the range of 0 to 300° C. according to the desired products. However, in order to control the reaction speed and the form of products, the temperature is lowered and the reaction time is long, making it possible to change the products.

Also, the reaction time in the present invention is not limited. In order to grow the particles, the reaction time may be long. In other words, in order to grow the size such as diamond, the reaction time may be long and theories used for the crystal growth such as a general sol-gel method may be applied according to the targeted products.

Also, at the step of inputting the base of the present invention, several metals such as copper, silver, etc. nonmetals and inert gases are doped in a molecule state or an ion state or several metals in a metal state or an ion state may be impregnated in the carbon particle.

Also, the metal salt or the metal oxide, etc. may be impregnated in the carbon particle.

Also, the desired particular organic compounds may be impregnated in the carbon particle during the reaction and metals, such as iron, cobalt, nickel, etc. is used in the state where they are directly impregnated into a carrier or in the chelating state so that they may be changed into a form of carbon such as nanodiamond, carbon nanotube, carbon nanofiber, nanographite, carbon onion, diamond nanotube, etc.. For example, the carbon onion may be prepared by a use of catalyst and the products may be changed according to a selection of the kinds of catalysts and the combination of reaction substances.

Also, several metal plates such as nickel, etc are input to the reaction solution to perform dehydrohalogenation reaction so that the graphite sheet or the diamond sheet with the nano size may be formed prepared on the surface of the metal plate and likewise, the carbon layer such as the nanographite or the nanodiamond, etc. may be formed on the surfaces of several objects such as metal, ceramic, plastic, fiber, carbon nanotube, optical fiber, separating membrane, etc. In other words, as in examples of a tenth embodiment and an eleventh embodiment, a synthetic method of nanocarbon is performed on a target intending to form the carbon layer dipped into a reaction solution so that the carbon layer is formed on the surface of the target.

When metal or ceramic is coated with the nanographite or the nanodiamond, etc., the parts to be cut are very robust and have large abrasion resistance so that the working speed can be improved and the exchange cycle can be long. In the parts whose abrasion resistance is important, this technology increases a required period for repairing a partial machining process and an entire process, making it possible to steadily contribute to an improvement of productivity.

Also, when ceramic or polymer membrane is input to the reaction solution to perform the dehydrohalogenation reaction, the nanodiamond, etc, may be produced between the pores of the membrane. The pore size of the separating membrane is controlled through the method so that the pore with a precise nano size can be prepared and the hydrophilic property is imparted to the separating membrane so that antifouling property is increased and fluids such as a significant amount of water can be processed as compared to the non-coated membrane with the same pore size. This can be applied to several membranes such as polyvinylidene fluoride membrane, Teflon membrane, polypropylene membrane, polyethylene membrane, etc. The size of nanocarbon is significantly grown between the pores so that it can be used as a membrane of gas and can be prepared as the separating membrane passing through only hydrogen.

In particular, since diamond has excellent biocompatibility, the surfaces of the objects such as an artificial internal organ, etc. inserted into a living body are coated with carbon or diamond, making it possible to significantly reduce side effects within the living body.

Also, diamond, nanographite, etc. prepared to have the nano size may be used as solid lubricant, etc and are applied with proton beam, etc. so that they may be prepared as an ultralight, ultrafine nano magnet.

Since the nanodiamond coating has excellent antibiosis and antifouling property, it is applied to parts in a heat exchanger such as an air conditioner, etc. The parts and objects, etc., requiring the antibiosis and the antifouling property are applied with the nanodiamond coating with the excellent durability and abrasion resistance.

Also, a core shell structure may be prepared by preparing the nanodiamond by means of a smooth control of the reaction conditions during the reaction and by forming the carbon onion layer thereon. In this case, it can be used for the lubricant requiring a separate special performance, etc. The nanodiamond is used as lubricant additive and the nanodiamond coated with carbon may also be used as the lubricant additive.

Recently, the nanodiamond is widely applied to a drug delivery system. The nanodiamond prepared by this method can be prepared without including heavy metals. This nanodiamond is very clearly prepared while making the crystal growth. The inside of the nanodiamond prepared by an existing explosion method is provided with nitrogen and heavy metals. However, the nanodiamond prepared by this method does not nitrogen so that its purity is high, thereby improving several physical properties as compared to the nanodiamond prepared by the explosion method.

Oxidation is suppressed by coating carbon on copper at the point in time where a amount of silver (Ag) paste used has been gradually increased, making it possible to substitute inexpensive copper for expensive silver.

Also, an electrode is prepared using the prepared nanocarbon or the prepared nanocarbon may be applied to a super capacitor to manufacture products with high efficiency as well as may be applied to several fields such as energy savings, etc. by being used for a fuel cell, a secondary battery, a solar cell, a supercapacitor, a super conductor, a ferromagnetic material, medical supplies, cosmetics, a structure material, etc. at low costs.

Also, carbon substances including the prepared diamond is injected boron or nitrogen, etc. to improve electrical conductivity so that it may be used for improving conductivity and may be used as a material for a liquid crystal screen or a Braun tube and a next generation semiconductor. In the process preparing the nanodiamond, a method of simultaneously injecting boron or nitrogen can be used.

Next, at a purifying step in the present reaction, the produced substances attached to the surface of the targeted object may be purified by oxidation or reduction cleaning as intended, wherein water, solvent, acid, alkali, surfactant, etc may be used.

For example, a method of performing purification using an oxidation scheme including air and ozone at high temperature may be used and a method of performing purification in a liquid phase using peroxided water, sodium hypochlorite, chlorosulfonic acid, potassiummonopersulfate, ozone, or other oxide materials on an aqueous solution may be used. At this time, the methods may be used with UV light to promote the reaction or may be used with fluorinated surfactant to active the oxidation action.

Also, a method of directly contacting the produced substances with oxidant with strong oxidizing power in a solid state may be used and a method of using gases such as ozone with strong oxidizing power in a gas state, etc. may be used.

Also, at the purifying step in the present reaction, many methods may be used. Products in various forms such as a fiber form and a plate form can be prepared from carbon substance with very small molecular weight. Therefore, the purification may be performed according to the generally known conventional purifying methods, respectively, to be matched with the targeted object.

When purifying the fullerene, for example, a separating method using a column, a method capable of performing the purification using discrepancy in solubility of each solvent, or the like may be used and the discrepancy in solubility of solvent using the reaction with the fullerene and the nanodiamond with the metal base may be used. In particular, when preparing the nanocarbon, since the separating process consumes much time, a general method of separating the nano particles such as a high-speed centrifugal method is properly used to achieve the good separation. It can be allowed to evaporate and remove the remaining amines and solvents before the separation. In this process, it can be allowed to recover all the amines using an inorganic base. The separation time is shortened by well selecting the amount of solvent and water.

Also, it can be allowed to use the membranes capable of performing nano filtration. The material of the membrane is not limited. Also, the Teflon membrane, etc. may be purified using the nanocarbon or nanodiamond coated membrane in accordance with the technology of the present invention and the membrane with the controlled pore size and the improved surface property by the coating of the nanocarbon or nanodiamond on other ceramic membranes or other polymer membrane may be used.

### DESCRIPTION OF DRAWINGS

The above and other objects, features and advantages of the present invention will become apparent from the following description of preferred embodiments given in conjunction with the accompanying drawings, in which:

FIG. 1 is a view showing powder Raman 488 nm data of a first embodiment;

FIG. 2 is a view showing Raman 488 nm data on an aqueous solution of the first embodiment;

FIG. 3 is a view showing a TEM photograph (nanodiamond SP3 structure) of the first embodiment;

FIG. 4 is a view showing a TEM photograph-nanodiamond SP3 structure of a second embodiment; FIG. 5 is a view showing a TEM photograph of a third embodiment;

FIG. 6 is a view showing a TEM photograph-nanodiamond SP3 structure of a third embodiment;

FIG. 7 is a view showing a TEM photograph-nanodiamond SP3 structure of a fourth embodiment;

FIG. 8 is a view showing a TEM photograph-nanodiamond SP3 structure of a fifth embodiment;

FIG. 9 is a view showing a TEM photograph-nanodiamond SP3 structure of a sixth embodiment;

FIG. 10 is a view showing a liquid chromatograph/tandem mass analysis of a seventh embodiment;

FIG. 11 is a view showing Raman 514.5 nm Data in an aqueous solution of the seventh embodiment;

FIG. 12 is a view showing a TEM photograph of an eighth embodiment;

FIG. 13 is a view showing a TEM photograph of a ninth embodiment;

FIG. 14 is a view showing Raman 448 nm Data of the ninth embodiment;

FIG. 15 is a view showing infrared spectra data of PTFE Film of a tenth embodiment; and

FIG. 16 is a view showing infrared spectra data of Nylon 66 Cable Tie of an eleventh embodiment.

### BEST MODE

Hereinafter, the present invention will be described in detail through embodiments preparing carbons with the compound of 1:1 atomic number ratio of hydrogen and halogen among chemical compounds of carbon, hydrogen, and halogen by dehydrohalogenation, but is not limited thereto.

### First Embodiment

After a mixture of 20 g vinylidene chloride and 120 g N-methylmorpholine is input into a 500 ml high pressure reactor, the reactor is sealed and its temperature is raised to 140° C. Thereafter, it causes a reaction the mixture for 48 h. The products are filtered with a filter paper and the filtered substances on the filter paper are further cleaned with methyl alcohol. Thereafter, they are dried and washed, thereby obtaining the resultant products.

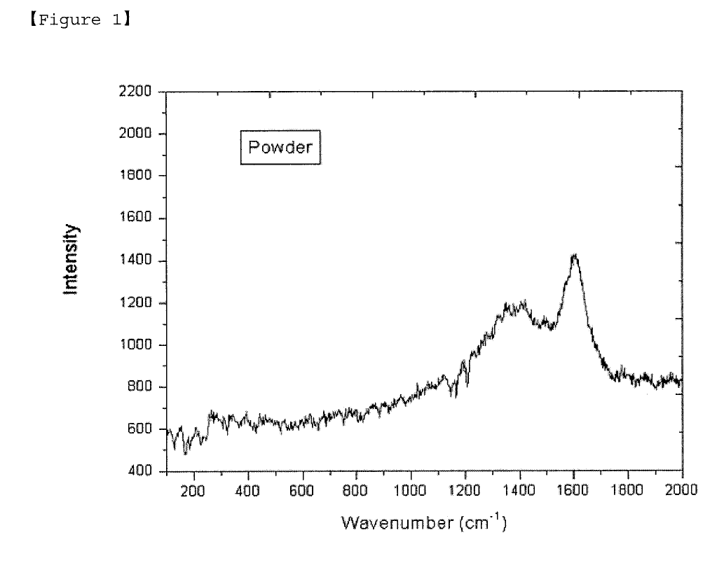

These powder substances are analyzed by Confocal Raman Microscope Spectrometer RS-1 488 nm and the results are shown in FIG. 1. A large peak appears near 1590 cm⁻¹ so that the formation of graphite can be appreciated.

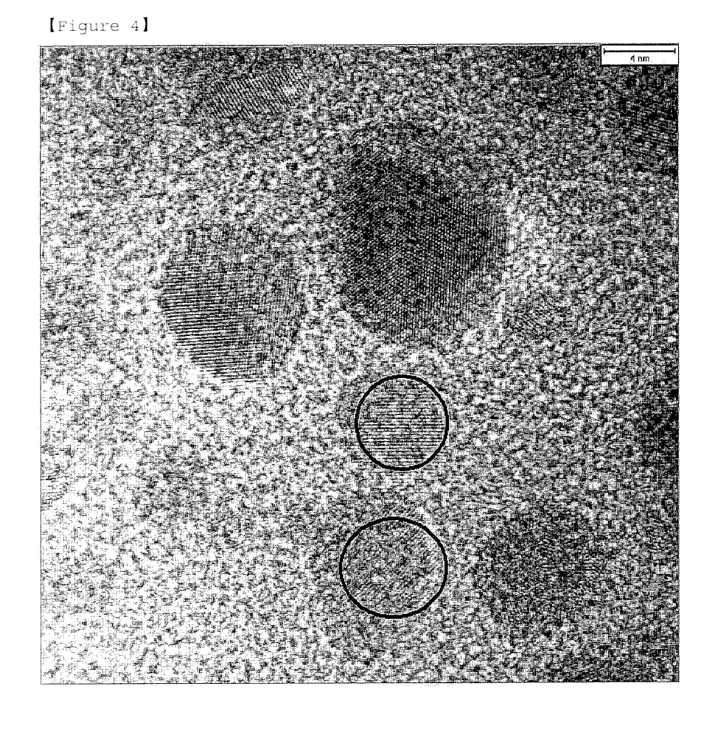

In the cleaning process, the substances passing through the filter paper is input and dried in a rotary evaporator and the dried substances are then dispersed in water to make them an aqueous solution state. Thereafter, they are back analyzed by the Confocal Raman Microscope Spectrometer RS-1 488 nm. It can be confirmed from the analyzed results that 1050 cm⁻¹, 1145 to 1150 cm⁻¹, 1332 cm⁻¹, and 1590 cm⁻¹ being the characteristic peaks of diamond with a nano size appear. Therefore, it can be appreciated that nanodiamond is prepared. It is believed that since a size in the particles of nanodiamond is fine, they pass through the filter together with cleaner when performing the cleaning with the methyl alcohol. It can be appreciated from a TEM photograph of FIG. 3 that the diamond with the nano size of the present invention is prepared. Also, it can be appreciated from the TEM photograph of FIG. 3 that an interlayer stacked structure marked by an oblique line by a SP3 combination of diamond with a nano size can be observed.

### Second Embodiment

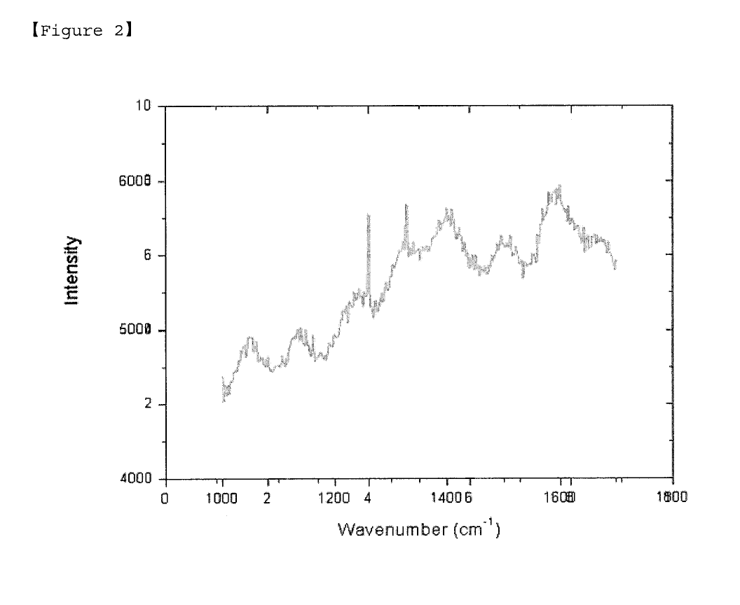

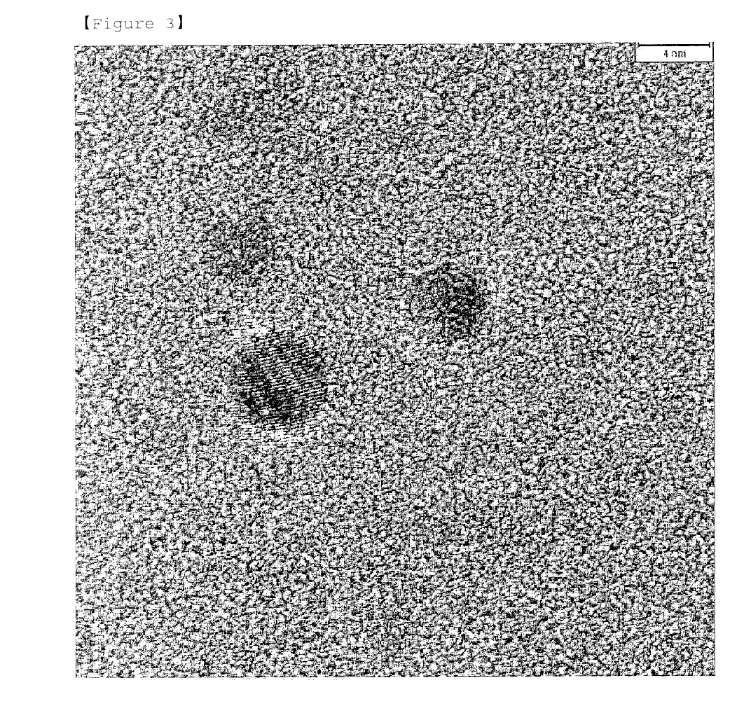

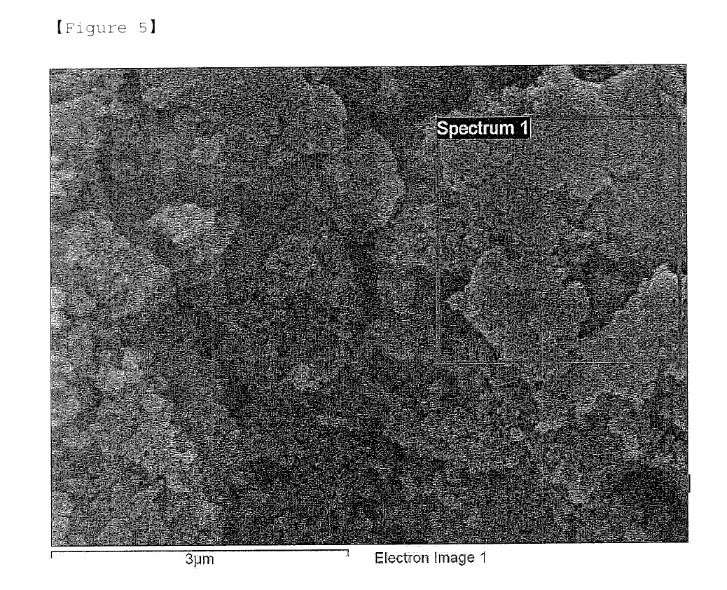

After a mixture of 30 g vinylidene chloride and 120 g N-methylmorpholine is input into a 500 ml high pressure reactor, the reactor is sealed and its temperature is raised to 70° C. Thereafter, it causes a reaction the mixture for 18 h. Then, its temperature is raised to 130° C. and it back causes a reaction the mixture for 48 h. The products are filtered with a filter paper and the filtered substances are dispersed in methyl alcohol to prepare a TEM sample. The TEM photograph is shown in FIG. 2. It can be appreciated from the TEM photograph of FIG. 4 that an interlayer stacked structure marked by an oblique line by a SP3 combination of diamond with a nano size can be observed.

### Third Embodiment

After a mixture of 60 g vinylidene chloride and 90 g dioxane and 0.18 g 2,2′-azobis(2,4-dimethylvalernitrile) is input into a 500 ml high pressure reactor, the reactor is sealed and its temperature is raised to 70° C. Thereafter, it causes a reaction the mixture for 5 h. Then, its temperature is raised to 80° C. and it back causes a reaction the mixture for 72 h. Next, the dioxane is removed with a rotary evaporator, thereby obtaining polyvinylidene chloride in a solid phase.

Then, transparent solution is prepared by stirring log polymer input into 500 g N-methyl pyrrolidone and at the same time, raising temperature to 80° C. Thereafter, the transparent solution is completely dissolved.

After confirming that color of the solution is deep by slowly dropping 100 N-methylmorpholine in the transparent solution for 1 h and at the same time, stirring it, the reaction is performed for 48 h after temperature is raised to 140° C. Thereafter, the products prepared after further inputting 20 g DBU(1,8-DIAZABICYCLO[5.4.0]UNDEC-7-ENE) and causing a reaction it for 48 h is diluted with water 100 times more than it, controlled to pH5 by hydrochloric acid, and subjects to precipitation and separation by a separating funnel five times, thereby obtaining the resultant products.

Carbon prepared as above is photographed by a SEM as in FIG. 5 and its element is analyzed. It can be appreciated from the analysis result that the carbon is synthesized.

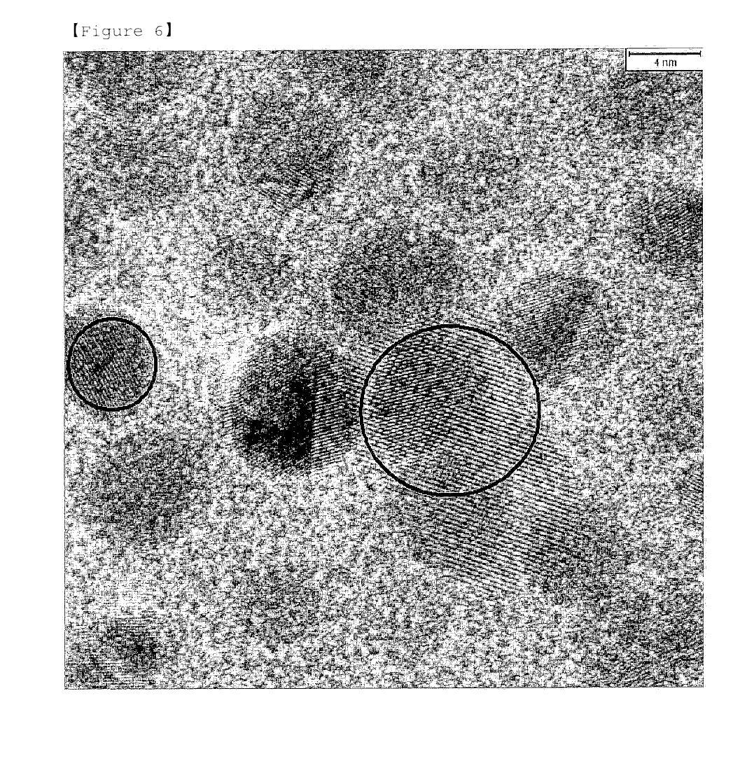

Also, after the solid attached to the bottom during the precipitation and separation is removed and the solid attached to the wall of the separating funnel is input into methyl alcohol and is redispersed, the particles are taken. Thereafter, a sample to be observed by a TEM is prepared. It can be confirmed that the nano particles observed from the TEM photograph of FIG. 6 has a lattice structure of diamond formed of the SP3 coupling.

### Fourth Embodiment

After 0.1 g 2,2′-azobis(2,4-dimethylvalernitrile) is dissolved with 100 g N-methylmorpholine and is then mixed with 20 g vinylidene chloride, it is input into a 500 ml high pressure reactor. Then, the reactor is sealed and its temperature is raised to 80° C. Thereafter, it causes a reaction the mixture for 24 h. Then, its temperature is raised to 95° C. and it back causes a reaction the mixture for 48 h.

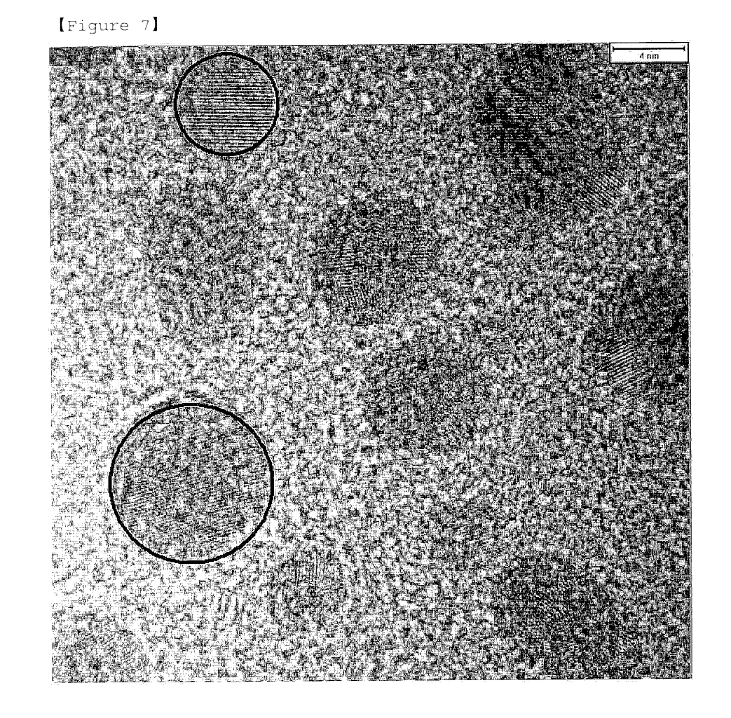

It can be appreciated that the amount of products is increased. The TEM photograph of the particles prepared as above is shown in FIG. 7. It can be confirmed that portions marked by an oblique line of the particles represented by a circle of the nano particles observed have a lattice structure of diamond formed of the SP3 coupling.

### Fifth Embodiment

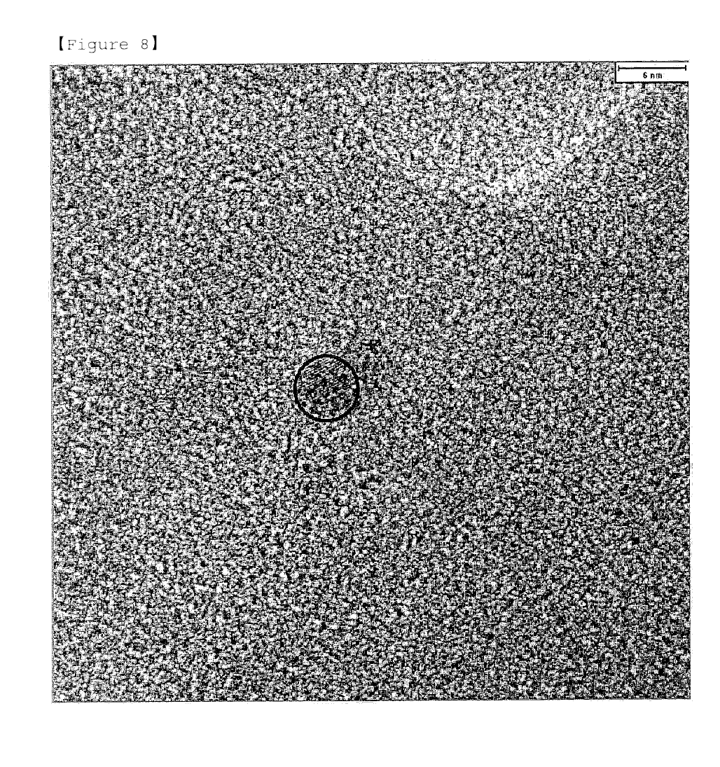

After a mixture of 20 trichloroethylene (1,1,2 trichloroethylene) and 150 g N-methylmorpholine is input into a 500 ml high pressure reactor, the reactor is sealed and its temperature is raised to 70° C. Thereafter, it causes a reaction the mixture for 18 h. Then, its temperature is raised to 130° C. and it back causes a reaction the mixture for 48 h. The products are input and dried in a rotary evaporator. Then, the dried substances are dissolved with methanol to prepare a TEM sample. The TEM photograph is shown in FIG. 8. It can be confirmed that nanodiamond is formed.

### Sixth Embodiment

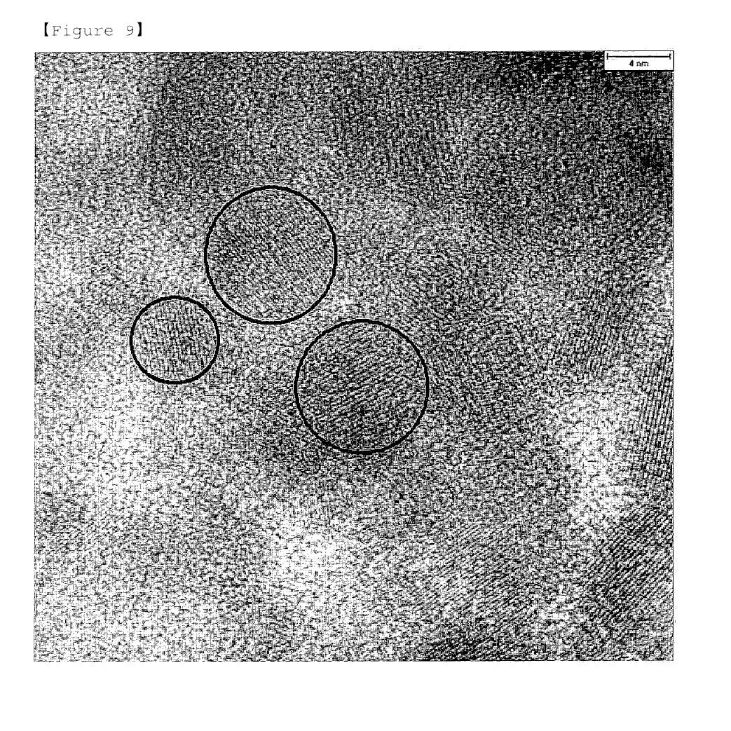

After a mixture of 20 g trichloroethylene(1,1,2 trichloroethylene) and 150 g N-methylmorpholine is input into a 500 ml high pressure reactor, the reactor is sealed and an stirrer is stopped. In this state, it causes a reaction the mixture for 18 h after temperature is raised to 70° C. Thereafter, the temperature is raised to 120° C. and the reaction is back performed for 96 h. The products are filtered with a filter paper and are then dispersed in water. At this time, a TEM sample is prepared. A TEM photograph is shown in FIG. 9. It can be confirmed that many nanodiamonds with a large size are prepared.

### Seventh Embodiment

20 g 1,2,4-trichlorobenzene and 80 g N-methylmorpholine are input into a high pressure reactor. Thereafter, the reactor is sealed and its temperature is raised to 120° C. Then, it causes a reaction the mixture for 24 h. Next, its temperature is raised to 130° C. and it back causes a reaction the mixture for 24 h. light brown products therefrom is fixed and precipitated. Thereafter, the precipitates are cleaned with acetone and then dried, thereby obtaining light brown crystal grown in a needle type.

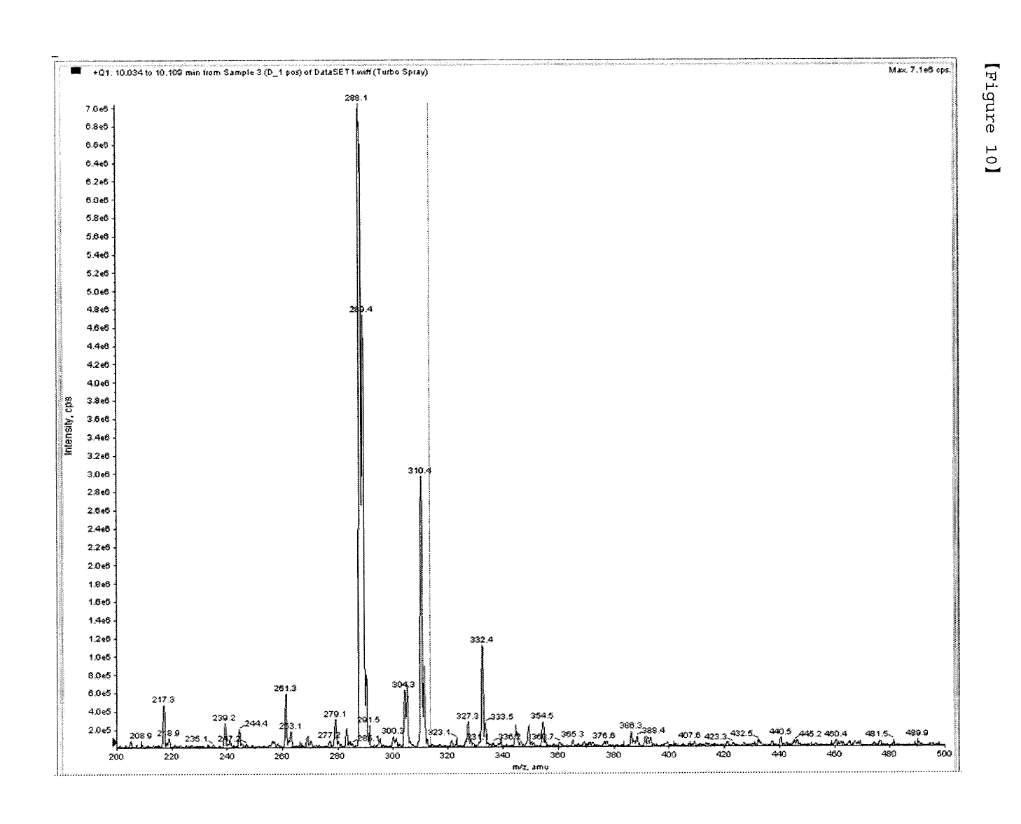

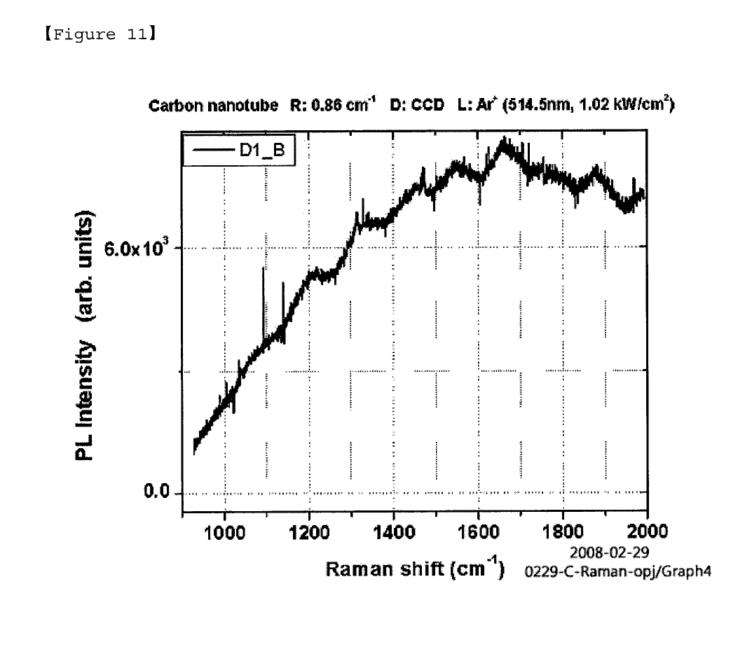

This crystal is diluted with water to prepare a yellow aqueous solution. This solution is analyzed by a liquid chromatograph/tandem mass spectrometry model 4000 Q TRAP. A mass analysis sheet therefrom is shown in FIG. 10. At this time, a peak of fullerene C₂₄ (molecular weight 288) is confirmed in molecular weight 288.1.

### Eighth Embodiment

After a mixture of 20 g vinylidene chloride and 100 g N-methylmorpholine is input into a 500 ml high pressure reactor, the reactor is sealed and its temperature is raised to 70° C. Thereafter, it causes a reaction the mixture for 18 h. Next, its temperature is raised to 140° C. and it back causes a reaction the mixture for 24 h.

The 0.2 g solution of products prepared as above is taken. It is mixed with the mixture of 20 g vinylidene chloride and 100 g N-methylmorpholine. Then, the mixture is input into a 500 ml high pressure reactor. Thereafter, the reactor is sealed and its temperature is raised to 110° C. Thereafter, it causes a reaction the mixture for 24 h. Next, its temperature is raised to 130° C. and it back causes a reaction the mixture for 72 h.

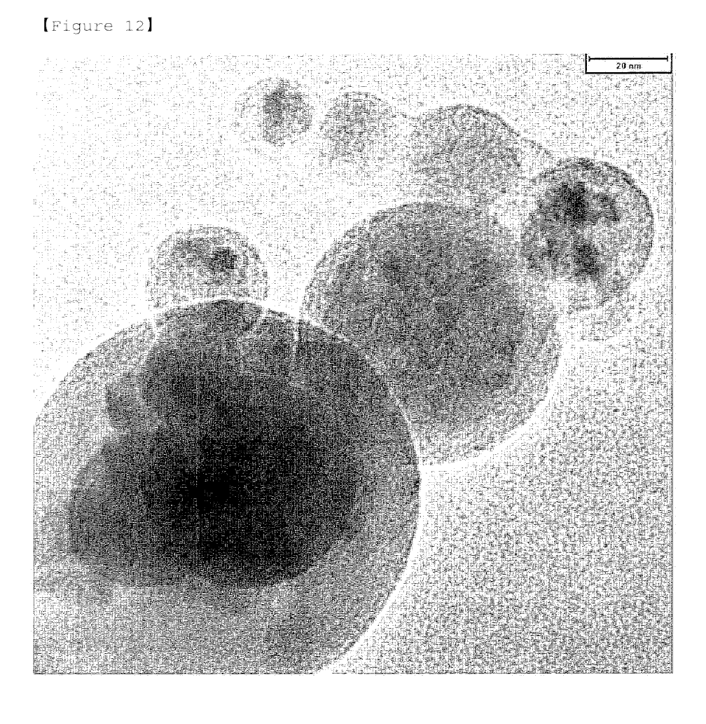

The products are dried by a rotary evaporator and are then diluted with methanol to prepare a TEM sample. A TEM photograph is shown in FIG. 12. It can be appreciated that a size in particles is increased to 20 nm to 100 nm.

### Ninth Embodiment

After a mixture of 20 g vinylidene chloride and 100 g N-methylmorpholine is input into a 500 ml high pressure reactor, the reactor is sealed and its temperature is raised to 65° C. Thereafter, it causes a reaction the mixture for 45 h. Next, its temperature is raised to 95° C. and it back causes a reaction the mixture for 48 h. The reactant is diluted with methyl alcohol to prepare a TEM sample.

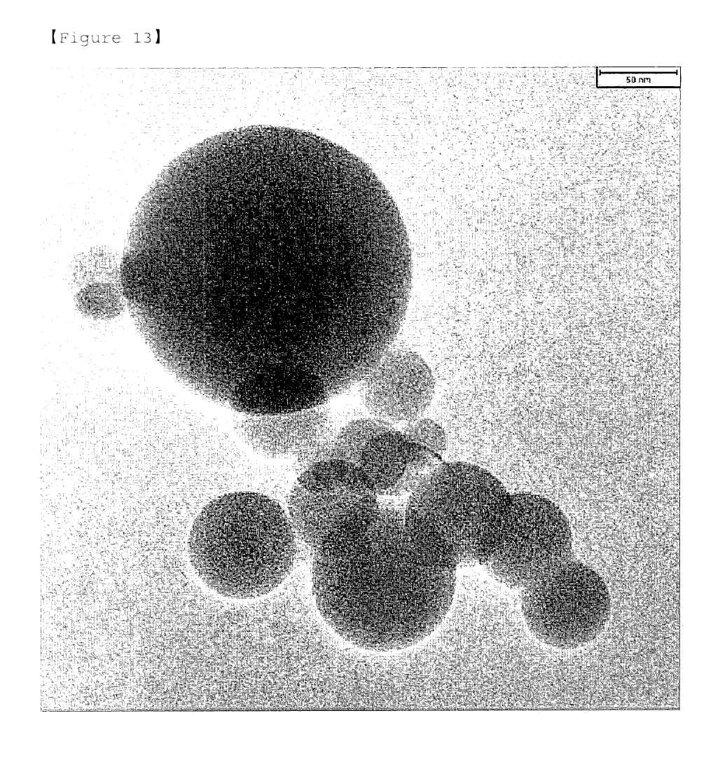

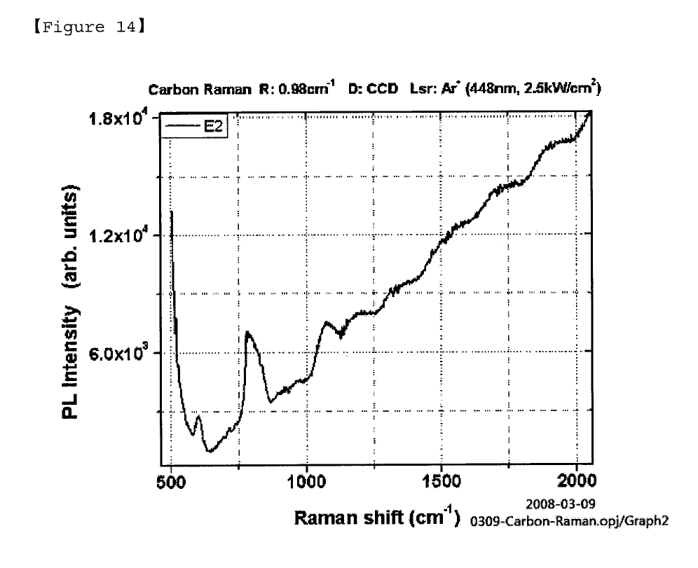

The results photographing this sample with a TEM are shown in FIG. 13. It can be confirmed that a size in particles is increased by a low temperature reaction. It can be appreciated from results analyzed by Raman 488 nm (FIG. 14) that a large peak appears at 1050 cm⁻¹ when there are many SP3 couplings.

### Tenth Embodiment

After six sheets of film cutting Teflon Membrane Filter-Poreflon WP-045-80 Poresize 0.45 micro meter film available from Sumitomo Electronic Ind., Ltd. at 1.5 cm by 15 cm together with 80 g N-methylmorpholine and 20 g vinylidene chloride is input into a 500 ml high pressure reactor, the reactor is sealed and its temperature is raised to 70° C. Thereafter, it causes a reaction them for 18h. Next, its temperature is raised to 120° C. and it back causes a reaction them for 24 h.

The film is taken out of the reaction solution after the reaction. Thereafter, it is washed with water several times and is then dried.

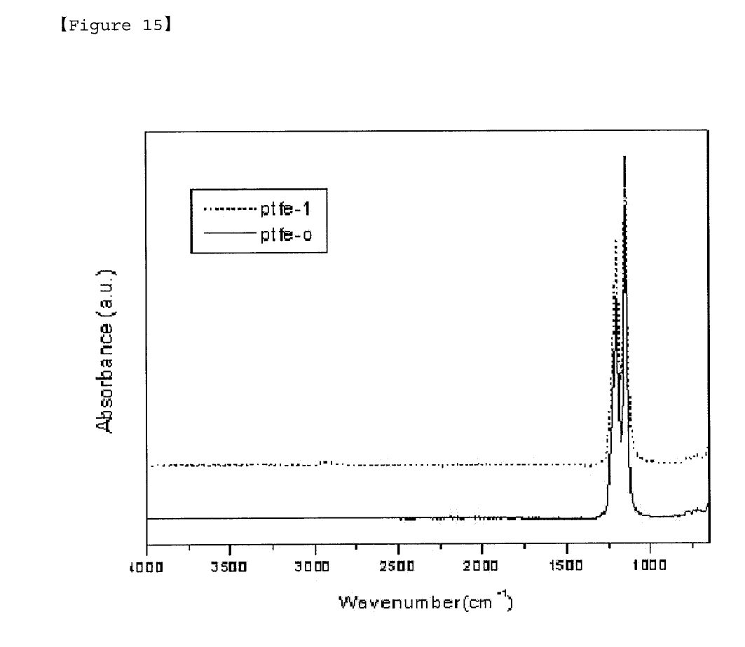

It can be confirmed from the results (see FIG. 15) photographed with IR that the analyzing values of an original film and the film taken out of the reaction solution are identical so that the film is not damaged.

It can be confirmed that the original film is floated on the surface of water when it puts in the water while the newly prepared film is sunk in the water due to hydrophilic property produced by coating diamond on the surface thereof when it puts in the water. In order to analyze this, a contact angle test of the film is performed with Contact Angle Measurement DSA 100 available from KRUSS Co.

The contact angle of the non-coated original Teflon film to water is measured by 137.2° and the contact angle of the coated Teflon film to water is measured by 124.2°.

### Eleventh Embodiment

After four Nylon 66 (generally used cable tie) cut at 5 cm long together with 80 g N-methylmorpholine and 20 g vinylidene chloride are input into a 500 ml high pressure reactor, the reactor is sealed and its temperature is raised to 70° C. Thereafter, it causes a reaction them for 18 h. Next, its temperature is raised to 120° C. and it back causes a reaction them for 24 h.

Pieces are taken out of the reaction solution after the reaction. Thereafter, they are washed with water several times and are then dried.

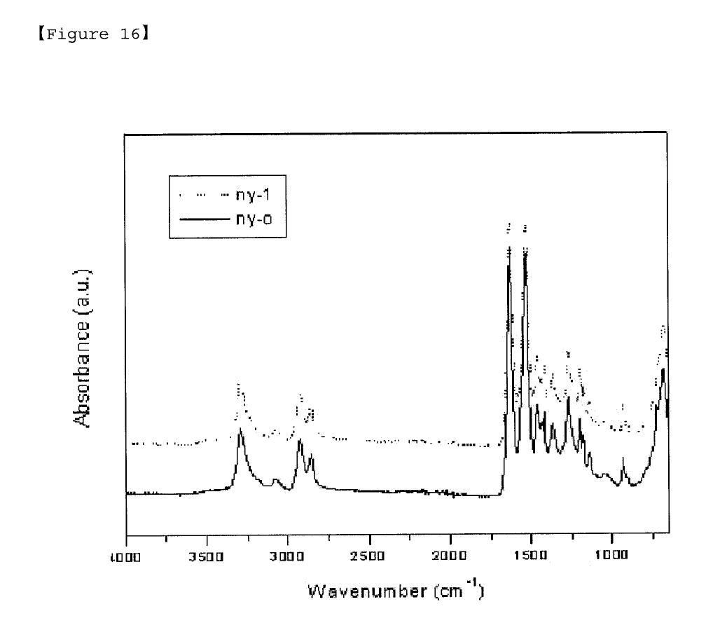

It can be confirmed from the results (see FIG. 16) photographed with IR that the analyzing values of original tie pieces and the tie pieces taken out of the reaction solution are identical so that the surface is not damaged.

In order to analyze the difference, a contact angle test of the pieces is performed.

The contact angle of the non-coated original Nylon 66 cable tie piece to water is measured by 78.5° and the contact angle of the coated Nylon 66 cable tie piece to water is measured by 80.3°.

### INDUSTRIAL APPLICABILITY

The present invention provides a new preparation method of carbons in various forms with the compound of 1:1 atomic number ratio of hydrogen and halogen among chemical compounds of carbon, hydrogen, and halogen by dehydrohalogenation. With the method, the carbons in various forms are mass-produced so that prices are remarkably lowered, thereby facilitating the product shipment to the market. Also, the carbons in various forms such as diamond can be economically prepared and very fine carbon particles such as nanodiamond, nanographite, fullerene, carbon onion, etc. can be prepared.

1-22. (canceled)

23. A preparation method of carbons selected from nanodiamond or fullerene by dehydrohalogenation, comprising the steps of:
preparing a reaction solution by directly using the compound of 1:1 atomic number ratio of hydrogen and halogen among chemical compounds of carbon, hydrogen, and halogen or by inputting and dissolving them into solvent;
inputting a base into the reaction solution; and
performing a reaction by raising temperature.

24. The method according to claim 23, wherein the base comprises at least one selected from the group consisting of compounds of metal amide, metal alkoxide, amine, ammonia, and metal oxide.

25. The method according to claim 23, wherein the reaction temperature reacts between 0 and 300° C.

26. The method according to claim 23, wherein a dispersant is further added together with the base.

27. The method according to claim 23, wherein a substance producing radical is further added together with the base.

28. The method according to claim 23, wherein at least one additive selected from metal, metal oxide, metal salt, organic compound, and metal chelate is further added together with the base.

29. The method according to claim 23, wherein a portion of product, purified product, or carbon substance capable of performing a role of seed or core is added together with the base.

30. A coated body surrounded by nanodiamond or fullerene prepared by inputting a targeted object to be coated into the reaction solution set forth in claim 23 and then performing dehydrohalogenation thereon.

31. The coated body according to claim 30, wherein the targeted object is any one selected from metal or ceramic, plastic, fiber, optical fiber carbon nanotube, or membrane.

32. The coated body according to claim 31, wherein the membrane is ceramic or polymer separating membrane and puts in a reaction solution to grow nano particles on the separating membrane during the reaction, thereby controlling a size in the pore.

33. The coated body according to claim 30, wherein the targeted object is Teflon or Nylon 66.

34. The preparation method according to claim 23, wherein substances in a gas phase of nitrogen, helium, neon, or a mixture thereof are input into a reactor together with the base to be included in the inside of the carbons particle.

35. The method according to claim 23, wherein the compound is any one selected from vinylidenehalide, trihaloethylene, trihaloethane, dihalomethane, trihalobenzene, tetrahalonaphthalene, or polyvinylidenehalide.

36. The method according to claim 35, wherein the compound is any one selected from polyvinylidene chloride, vinylidenechioride, trichloroethylene, trichloroethane, dichloromethane, triehlorobezene, and tetraehloronaphthalene.
